(19) United States
(12) Patent Application Publication
(10) Pub. No.: US 2026/0369944 A1
(43) Pub. Date: Nov. 19, 2026

(54) GROMMET FITTING MODULE

(71) Applicant: Komax Holding AG, Dierikon (CH)

(72) Inventor: Thomas Bussman, Lauerz (CH)

(21) Appl. No.: 19/657,296

(22) Filed: Apr. 24, 2026

(30) Foreign Application Priority Data
May 15, 2025 (EP) 25176768.7

(51) Int. Cl. H01R 43/00; H02G 1/14

(52) U.S. Cl. CPC H01R 43/005; H02G 1/14

(57) ABSTRACT

A grommet fitting module for fitting a grommet onto the cable end of a cable comprises a fitting head having an expansion sleeve and a grommet receiving part for receiving and holding the grommet during the fitting process, as well as a transfer unit having four mandrels is disclosed. The expansion sleeve of the fitting head temporarily surrounds the mandrel in a transfer position, so that the grommet is slid onto the expansion sleeve by axially moving the grommet receiving part, and thereafter the grommet can be stripped off the expansion sleeve onto the cable by means of the grommet receiving part. The expansion sleeve and the grommet receiving part are implemented as replaceable parts. The grommet receiving part then has an end face that forms a stop for defining a sliding-on stroke that cooperates with a counterpart associated with the grommet receiving part.

### TECHNICAL FIELD

The invention relates to a grommet fitting module for fitting a grommet onto the cable end of a cable. With such a grommet fitting module, grommets, which are required for example for moisture-tight feedthroughs of electrical cables through connector housings or housing walls of electrical appliances, can be applied to cables.

### BACKGROUND

In the production of cables, cable may be cut to length and stripped, fitted with grommets, crimped, and optionally provided with housings. For this purpose, a stripped cable is fitted with a grommet, and then, usually, a metal contact is crimped. This crimp contact is designed so that it fastens the grommet on the cable. Automated or semiautomatic machines are frequently used for the assembly of cables whereby, in a semiautomatic machine, the cable is manually fed to the respective processing station.

A generic, comparable grommet fitting module is known from EP 0 626 738 A1. In this case, the grommet fitting module is part of a grommet station comprising a grommet storage unit with a drum filled with grommets and the aforementioned grommet fitting module for fitting a grommet onto a stripped cable end of a cable. By means of a conveyor rail, the grommets are transported in the correct position to a separating unit, from which grommets are individually pushed onto a mandrel of a transfer unit. The transfer unit is designed as a turning device and comprises a total of four mandrels. In addition to the referenced transfer unit with the four mandrels, the grommet fitting module further comprises a fitting head with an expansion sleeve. At the end of the separating unit, an ejection device is arranged with a tappet which can be moved up and down, with the tappet in each case feeding the first grommet in the conveyor rail to the transfer device. The transfer device is successively pivotable around a 90° angle, wherein, in a first position, the grommet is pushed onto the mandrel by means of said tappet. After a rotation around 90°, the grommet is pushed in a second position of the transfer unit for the purpose of expansion onto an area of the mandrel with a larger diameter. The actual fitting of the grommet onto the cable end takes place in a third position. In this third position of the transfer device, the grommet is removed from the mandrel using the fitting head with a grommet receiving part and expansion sleeve, and the grommet in the expanded state is placed on the cable and finally pushed thereon. Once the mandrel has been pivoted to the third position, the fitting head encloses the grommet with the two-part expansion sleeve and a two-part grommet receiving part, which is formed by two parts as well. By means of the grommet receiving part, the grommet is pushed onto the expansion sleeve. To this end, the grommet fitting module can comprise a pneumatic sliding-on and stripping drive for moving the grommet receiving part. According to the prior art, this movement can be limited by a piston rod nut that is seated on a piston rod of the pneumatic sliding-on and stripping drive and defines a stop. The grommet receiving part can be moved along a longitudinal center axis until the piston rod nut hits the fitting head housing. This results in the sliding-on stroke. The expansion sleeve, which is arranged upstream from the grommet receiving part, has a widened region at the front end facing the cable with a funnel-shaped insertion opening for the insertion of the cable into the closed fitting head. In practice, it has been found that this grommet fitting station requires a relatively large cable projection. In fully automated grommet stations, for example, the cable must protrude on a cable gripper, which brings the cable to the fitting head, by this cable projection and may sag accordingly. When feeding the cable with the gripper, undesired vibrations and motions may occur, and the handling of particularly thin cables may be difficult. Another difficulty is that processing different items with the grommet station requires complex changeover work on the grommet fitting module. For example, after the changeover, it is necessary to reconfigure and adjust the grommet fitting module, for example by adjusting the axial position of the piston rod nut on the piston rod by turning it. These adjustments are complex and require a high degree of care. Furthermore, due to incorrect settings, for example, due to an excessively large sliding-on stroke, tools such as, in particular, the expansion sleeve can be damaged.

### SUMMARY

It is therefore an object of the present invention to avoid the known disadvantages and in particular to provide a grommet fitting module with which cables may be provided with grommets in a reliable and efficient manner. The grommet fitting module is intended to be implemented in such a way that it allows for simple and rapid changeovers to new or different grommets.

This object is achieved according to the invention by the grommet fitting module having the features of the present disclosure. The grommet fitting module for fitting a grommet onto the cable end of a cable comprises a preferably pneumatically driven fitting head and a transfer unit having at least one mandrel. The grommet fitting module can be part of a grommet station, which, in addition to the grommet fitting module, can comprise a grommet storage unit having, for example, a drum filled with grommets. By means of a conveyor rail, the grommets can be transported in the correct position to a separating unit, from which grommets can individually be pushed onto a mandrel of the transfer unit. The fitting head has an expansion sleeve extending along a longitudinal center axis for holding the grommet in an expanded state and a grommet receiving part for receiving and holding the grommet during the fitting process and for placing the grommet onto the cable end. The transfer unit having the at least one mandrel is implemented such that in a transfer position a grommet is slidable onto the mandrel in a first mandrel portion and in a transfer position is in operative engagement with the fitting head such that the grommet can be transferred from the mandrel to the fitting head. In the transfer position, the expansion sleeve of the fitting head temporarily surrounds the mandrel, so that the grommet can be slid onto the expansion sleeve by means of the grommet receiving part, or more precisely by axial movement (i.e., displacement in the direction of the aforementioned longitudinal center axis) of the grommet receiving part, and thereafter the grommet can be stripped off the expansion sleeve onto the cable by means of the grommet receiving part. This movement is to be understood as a relative movement, but preferably only the components or tools (i.e., the grommet receiving part and/or the expansion sleeve) of the fitting head are moved, and the cable end is held in place or remains stationary during at least part of or even throughout the entire fitting process. By virtue of the fact that the expansion sleeve and/or the grommet receiving part, to allow for a tool change, are implemented as replaceable parts that are detachably fastenable to the fitting head and removable from the fitting head again, and that, for defining the sliding-on stroke, the grommet receiving part or the expansion sleeve is provided with a stop that, for limiting the maximum possible sliding-on travel (sliding-on stroke), cooperates with a counterpart associated with the expansion sleeve or the grommet receiving part, a plurality of advantages are achieved. It is intended to provide a grommet fitting module by means of which cables can be reliably and efficiently fitted with grommets. This, since a preferably fixed stop is integrated in the grommet receiving part or expansion sleeve implemented as a replaceable part, the grommet fitting module can be changed over quickly and efficiently and prepared for new or different grommets. Subsequent adjustment to determine the sliding-on stroke is unnecessary. The grommet station can be ready for operation immediately after the replacement process.

To slide the grommet onto the mandrel in the pick-up position, the grommet fitting module can further have an ejection device having a tappet that can be moved up and down, with which the first grommet can be supplied from the conveyor rail to the transfer device, in this supply process this grommet being slid onto the mandrel for the first time. Furthermore, a mandrel sliding-on unit can be provided in the grommet fitting module, by means of which, in a further and, in particular, in a second position of the transfer unit, the grommet is slid onto a second mandrel portion of the mandrel for the purpose of expansion, the diameter of which is larger than that in the region of the first mandrel portion.

According to one embodiment, the grommet receiving part can have an end face that forms the stop for defining the sliding-on stroke. Such an end face can, for example, be a planar stop surface extending perpendicular to the longitudinal center axis. Such a stop can easily be created from a metal component, for example, by means of a machining process.

Preferably, the grommet receiving part can be configured in two parts in a manner known per se and have two radially counter-movable jaws having receptacles for the grommet, each jaw having a grommet receiving portion having a recess for forming the grommet receptacle and a fastening portion adjoining the grommet receiving portion, via which fastening portion the particular jaw is fastened or fastenable to the fitting head. In this case, the end face can be formed by the fastening portion(s). The grommet receiving part configured in two parts can therefore have two stops, since each of the fastening portions can each have an end face or an end face segment, and a counterpart is arranged opposite each end face segment. In principle, it would also be conceivable to use only one of the end faces of the fastening portions as a stop.

Particularly preferably, the jaws of the grommet receiving part are configured as one-piece components, at least with respect to the fastening portion and the grommet receiving portion. The grommet receiving portion and the fastening portion can thus be monolithically joined together and produced from a single workpiece. The grommet receiving part having the grommet receiving portion and the fastening portion can have an L-shape in plan view.

The fastening portion can be designed as a substantially cuboid body. The grommet receiving portion can preferably be configured as a hollow body having a frame structure that is particularly preferably rectangular in plan view, which rectangle has two parallel wall portions extending transversely to the longitudinal center axis for sliding onto and stripping off the expansion sleeve. The aforementioned wall portions are a front and a rear wall portion, the grommet, when it is received in the grommet receiving portion, being slid onto the expansion sleeve via or together with the front wall portion, and the grommet is stripped off the expansion sleeve via or together with the rear wall section.

The cuboid body and the hollow body are preferably integrally formed with one another and produced from a single workpiece.

It can be advantageous if the fastening portion of the jaw has an end facing the cable, i.e., a front end with respect to the longitudinal center axis and the direction of movement, for forming the end face, the end face preferably being designed to be flat, thus resulting in a defined stop for a particularly precise setting of the sliding-on stroke.

Particularly advantageously, the front end of the fastening portion forming the stop is arranged offset rearward, relative to the grommet receiving portion, and more precisely relative to a front end of the grommet receiving portion, in the grommet receiving part, and more precisely in the particular jaw of the grommet receiving part.

For the grommet receiving part, a support part can be provided for each jaw, the two support parts, together with the jaws, being radially counter-movable between the open position and the closed position, and the particular support part having a workpiece receptacle for positive insertion of the fastening portion into the workpiece receptacle. The support part inserted into the workpiece holder is secured, for example, by means of a screw connection.

A flange portion for forming a sleeve holder having a funnel-shaped insertion portion can adjoin the expansion sleeve, the expansion sleeve being configured in two parts and having two radially counter-movable shell parts, and the sleeve holder also being configured in two parts and having two flange portions that are radially counter-movable together with the shell parts and are preferably plate-shaped. To form replaceable parts, the expansion sleeve, or the expansion sleeve thereof, is detachably fastened or fastenable to the fitting head via the flange portion or sleeve holder.

The counterpart for the stop can be arranged in or on a housing of the fitting head that is stationary with respect to the fitting head, i.e., not removable together with the expansion sleeve. The counterpart therefore remains on the housing of the fitting head and cannot be removed together with the expansion sleeve.

Alternatively, the counterpart for the stop can be arranged on the expansion sleeve and, in particular, on a flange portion as a sleeve holder, which can be removed from the fitting head and replaced together with the expansion sleeve.

It can also be advantageous if the counterpart is a stud-shaped stamp. The counterpart can therefore be formed by a stud-shaped stamp projecting relative to an inner side of the housing or an inner side of the flange portion, and, in particular, by a stud-shaped protrusion.

If the grommet fitting module, in the case of use of the previously described two-part grommet receiving part, has two stops, a counterpart can be arranged opposite each end face or each end face segment of the grommet receiving part. Thus, the grommet fitting module can comprise two stamps in the form of stud-shaped protrusions.

The counterpart formed by a stamp can be integrally connected to the adjacent inner side of the housing and arranged rigidly in the housing of the fitting head. Thus, the sliding-on stroke is varied by selecting different grommet receiving parts depending on the grommet and inserting them into the grommet fitting module or otherwise connecting them thereto.

The housing of the fitting head can have, for each part of the grommet receiving part configured in two parts, a pocket-shaped receiving opening, into which the particular part of the grommet receiving part is insertable and removable again via the particular flange portion.

The grommet fitting module can have, for moving the fitting head along the longitudinal center axis, a pneumatic or pneumatically operated head drive and a pneumatic or pneumatically operated sliding-on and stripping drive. The head drive can preferably comprise two pneumatic cylinders; the sliding-on and stripping drive can have one pneumatic cylinder.

### BRIEF DESCRIPTION OF THE DRAWINGS

Further individual features and advantages of the invention emerge from the following description of exemplary embodiments and from the drawings. In the figures:

FIG. 1 is a perspective representation of a grommet station having a grommet fitting module;

FIG. 2 is a different perspective view of the grommet fitting module from FIG. 1 with a fitting head in the open position;

FIG. 3 shows a grommet receiving part of the fitting head of the grommet fitting module;

FIG. 4 shows the grommet fitting module with the closed fitting head at the beginning of the fitting process (step 1);

FIG. 5 shows the grommet fitting module after a grommet has been pushed onto an expansion sleeve of the fitting head in a first step (step 2);

FIG. 6 shows the grommet fitting module after a further movement of the fitting head, in which the grommet receiving part and the expansion sleeve were moved;

FIG. 7 shows the grommet fitting module after yet a further movement of the fitting head, in which the grommet was stripped off the expansion sleeve onto the cable (step 3);

FIG. 8 shows the grommet fitting module in the position according to FIG. 7, but now with the fitting head open (step 4);

FIG. 9 shows an upper part of the fitting head of the grommet fitting module, having a grommet receiving part for a long grommet, at the start of the fitting process (step 1);

FIG. 10 shows the fitting head of FIG. 9 after sliding the grommet onto the expansion sleeve (step 2);

FIG. 11 shows the fitting head of FIG. 9 after stripping the grommet (step 3); and

FIG. 12-14 show the upper part of the fitting head with a grommet receiving part for a short grommet in the positions analogous to FIG. 9-11.

### DETAILED DESCRIPTION OF THE EMBODIMENTS

FIG. 1 shows a grommet station for fitting grommets onto cables. Grommets are tubular or tube-like sealing elements, for example made of silicone, a rubber material, or other flexible plastic material, which are usually required for moisture-tight feedthroughs of electrical cables through connector housings or housing walls of electrical appliances.

The grommet station contains a grommet storage unit (not shown) and a grommet fitting module designated by 1 for fitting a grommet onto a stripped cable end of a cable 12. The grommet fitting module 1 comprises a fitting head 2 which extends along a longitudinal center axis 20 with which a grommet can be fitted onto the cable 12, which is also positioned along the longitudinal center axis 20. The grommet station may be used by itself or as part of a system for assembling cables which, besides the grommet station, may comprise further stripping stations, crimping stations, and, optionally, housing mounting stations.

The cable 12 is brought to the grommet fitting module 1 with a gripper (not shown here). The grommet station presented in this disclosure is a fully automatic design. However, it would of course also be conceivable to implement the grommet station, instead of a fully automatic machine, with the novel grommet fitting module 1 described in detail below in a semi-automatic version or in other variants.

A grommet storage unit of the grommet station can have a drum for the loose storage of a plurality of grommets. Via a conveyor rail 5 projecting into the rotating drum and visible in FIG. 1, the grommets reach the separating unit for correctly oriented storage and onward conveyance. By means of the separating unit, which has an ejection device having a tappet 13, which may be otherwise referred to herein as a plunger 13, the first grommet in the conveyor rail 5 can be supplied to the grommet fitting module 1. However, the grommet fitting module 1 described in detail below could also be combined with other grommet storage units or grommet supply devices. A grommet station without a grommet storage unit would also be conceivable. The grommets could be individually supplied manually to the grommet fitting module 1.

The preferably pneumatically driven fitting head 2 of the grommet fitting module 1 comprises an expansion sleeve 3 extending along the longitudinal center axis 20 for holding the grommet 11 in an expanded state and a grommet receiving part 4 for receiving and holding the grommet 11 during the fitting process and for placing the grommet 11 onto the cable end of the cable 12. The grommet fitting module 1 further comprises a transfer unit 7 having four mandrels 8, a grommet 11 being slidable onto a mandrel 8 in a pick-up position by means of the aforementioned separating unit having the plunger 13 in a first mandrel portion. The grommet fitting module 1 then comprises a mandrel sliding-on unit 14, by means of which, in a further position of the transfer unit 7, the grommet 11 is slid onto a second mandrel portion of the mandrel 8 for the purpose of expansion, the diameter of which is larger than that in the region of the first mandrel portion. In a transfer position, the mandrel 8 with the grommet 11 slid on in this way is in operative engagement with the fitting head 2 such that the grommet 11 can be transferred from the mandrel 8 to the fitting head 2. Here, in the transfer position, the expansion sleeve 3 of the fitting head 2 temporarily surrounds the mandrel 8, so that the grommet 11 is slid onto the expansion sleeve 3 by means of the grommet receiving part 4, and thereafter the grommet 11 can be stripped off the expansion sleeve 3 onto the cable 12 by means of the grommet receiving part 4, thereby completing placement of the grommet onto the cable end. The grommet receiving part 4 is moved axially, i.e., displaced in the direction of the aforementioned longitudinal center axis 20, while the cable end is held. Regarding the conveyor rail 5, the transfer unit 7 having the four mandrels 8 and the mandrel sliding-on unit 14, the grommet station shown in FIG. 1 substantially corresponds to the grommet station known from EP 0 626 738 A1. The fitting head 2 having the expansion sleeve 3 and the grommet receiving part 4 also resembles that of the prior art. Details regarding the configuration of the grommet storage unit having the drum, conveyor rail 5 and separating unit, as well as the design of the expansion sleeve 3 and grommet receiving part 4 and the basic mode of operation of the grommet fitting module 1 can be found in this document. The grommet fitting module 1 shown here and described in detail below is characterized by the fact that it allows for simple and rapid changeover with respect to new or different grommets. For this purpose, the expansion sleeve 3 and the grommet receiving part 4 are implemented as replaceable parts to allow tool changes. The expansion sleeve 3 and the grommet receiving part 4 are each detachably fastened to the fitting head 2 and can be separated from the fitting head 2 again. To define the sliding-on stroke, the grommet receiving part 4 is provided with a stop that cooperates with a counterpart 10 associated with the grommet receiving part 4 to limit the maximum possible sliding-on stroke. The push-off travel is a distance measured in the direction of the longitudinal axis 20.

The expansion sleeve 3 comprises an elongated portion which is cylindrical in the closed position with a sleeve tip onto which the grommet 11 can be pushed and a flange portion 24 which adjoins this portion. In this case, the sleeve tip is oriented toward the mandrel 8; the flange portion 24 forms the end for holding the expansion sleeve 3.

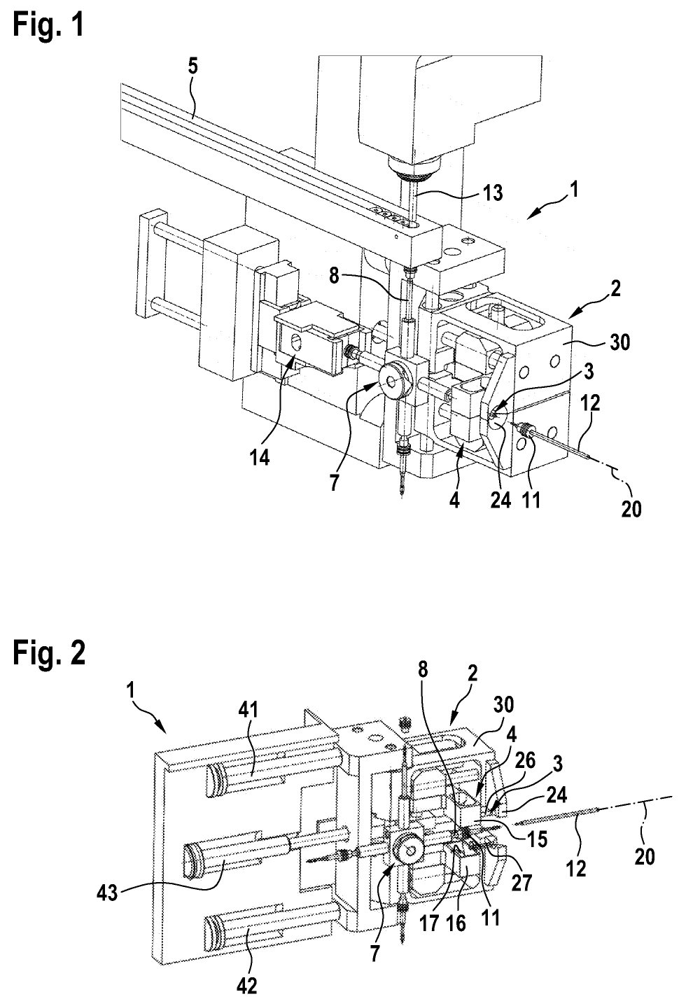

FIG. 2 shows the fitting head 2 of the grommet fitting module 1 in the open position. The mandrel 8 has been rotated 270° relative to the pick-up position and is now in the transfer position. The open fitting head 2 is positioned above the mandrel 8 with the grommet 11 pushed thereon. The grommet receiving part 4 is evidently formed in two parts and has two jaws 15, 16, radially counter-movable between the open position and a closed position, having receptacles for the grommet 11. Each jaw 15, 16 comprises a grommet receiving portion 17 having a recess for forming a grommet receptacle. The expansion sleeve 3 is formed in two parts and comprises two radially counter-movable shell parts 26, 27. The particular shell part 26, 27 comprises one half of the cylindrical portion and one half of the flange portion 24. The upper jaw 15 of the grommet receiving part 4 and the upper shell part 26 of the expansion sleeve 3 belong to an upper block of the fitting head 2; the lower jaw 16 of the grommet receiving part 4 and the lower shell part 27 of the expansion sleeve 3 belong to a lower block. The two blocks can be moved toward one another by means of a pneumatic drive (not shown here), which movement is indicated by arrows f₁and f₂. FIG. 2 further shows that the grommet fitting module for moving the fitting head 2 along the longitudinal center axis 20 has a pneumatic head drive and a pneumatic sliding-on and stripping drive. In the present case, the head drive comprises two pneumatic cylinders 41, 42. The sliding-on and stripping drive comprises a pneumatic cylinder 43.

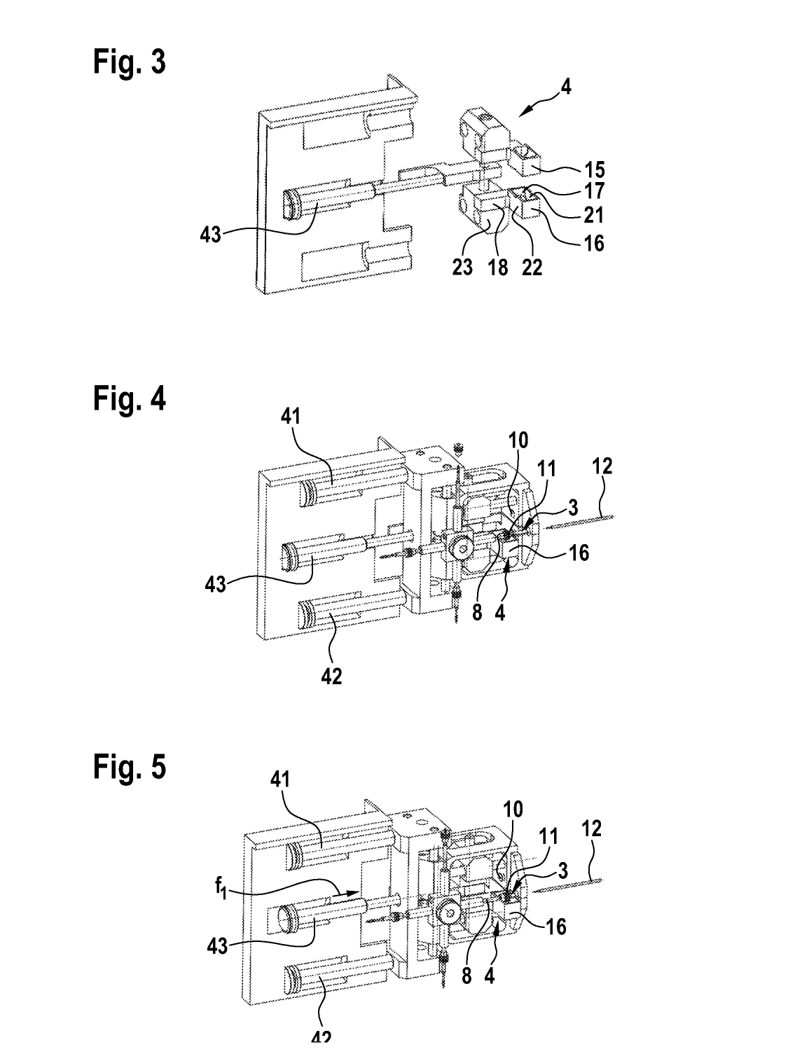

For a better understanding of the configuration of the grommet receiving part 4 and the associated sliding-on and stripping drive having the pneumatic cylinder 43, the components mentioned are shown individually in FIG. 3. The upper and lower grommet receiving portion 17 of the grommet receiving part 4 is in each case configured as a hollow body having a rectangular frame structure in plan view, which rectangle has two parallel wall portions 21, 22 running transversely to the longitudinal center axis 20. A cuboid-shaped fastening portion 18 adjoins the particular grommet receiving portion 17.

The jaws 15, 16 of the grommet receiving part 4 are in each case formed as one-piece components. The grommet receiving portion 17 and the fastening portion 18 of each jaw 15, 16 are monolithically connected to one another and are formed from a single metallic workpiece. In plan view, the grommet receiving portion 17 and the fastening portion 18 form an "L." The reference numeral 23 designates support parts for the jaws 15 and 16. The jaws 15, 16 can be removed from the support parts 23 for a tool change. Each support part 23 has a workpiece receptacle for the positive insertion of the fastening portion 18 into the workpiece receptacle. The jaw 15, 16 inserted into the workpiece receptacle is secured by means of a screw connection (not shown).

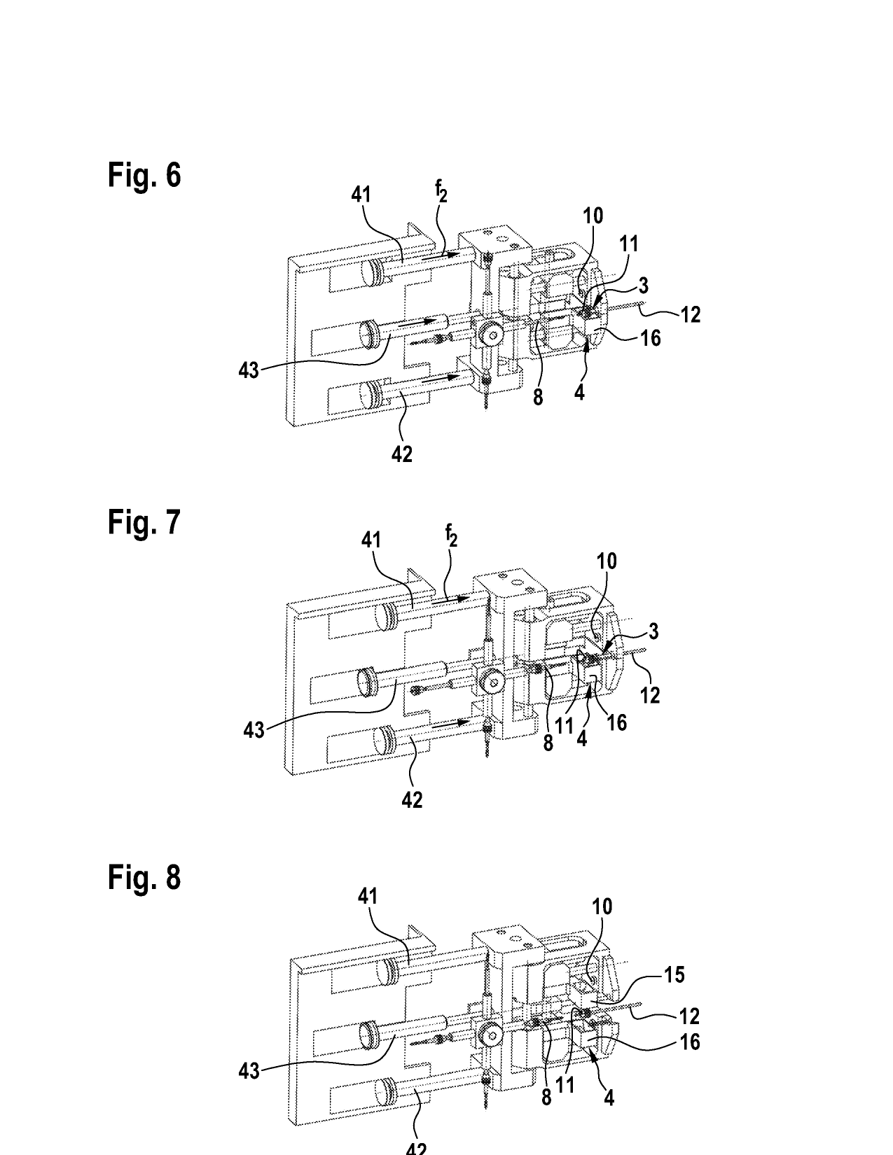

The fitting process - from the point in time after which the transfer unit 7 having the mandrel 8 is in operative engagement with the fitting head 2 such that the grommet 11 can be transferred from the mandrel 8 to the fitting head 2 - is explained below with reference to FIGS. 4-8. With the closing of the fitting head 2 as a first step, the grommet 11 on the mandrel 8 is enclosed by the grommet receiving part 4 (FIG. 4). In FIG. 4 and the following FIGS. 5-8, the upper part of the grommet receiving part 4 (i.e., the upper jaw 15) has been omitted for better understanding, so that the position of the grommet 11 is visible. The sliding-on and stripping drive comprising the pneumatic cylinder 43 is now extended - indicated by the arrow f₁ - and causes the grommet 11 by means of the grommet receiving part 4 to be slid onto the expansion sleeve 3, the cylindrical portion of which forms a tube in the closed state, which work step is hereinafter referred to as "step 2" and is shown in FIG. 5. In the present exemplary embodiment, the pneumatic cylinder 43 cannot be fully extended because the pneumatic cylinders 41, 42 of the head drive are still retracted and, due to the double piston area, hold the rest of the fitting head 2 in an initial position. Now the pistons of the two pneumatic cylinders 41, 42 of the head drive are also extended by pressurization, which causes the movement of the fitting head 2. This movement of the fitting head 2 in the direction of the cable longitudinal axis is indicated by an arrow f₂. In this process, the stationary cable 12 is guided over the inlet funnels of the expansion sleeve 3, thereby facilitating insertion of the cable end of cable 12 into the expansion sleeve 3. During this movement, the sliding-on and stripping drive reaches its extended position, as shown in FIG. 6. The fitting head 2 moves further in a further work step (step 3) until the pneumatic cylinders 41, 42 of the head drive also reach their end position. In this process, the stationary grommet receiving part 4 causes the grommet 11 to be pulled off the expansion sleeve 3 and positioned on the cable 12 (FIG. 7). The position of the grommet 11 on the cable 12 is determined with respect to the longitudinal center axis 20 by the position of the cable 12, which in the exemplary embodiment is held by a cable gripper not shown here. The cable end is held in place during step 3; it is also conceivable to hold the cable 12 in place during step 2 or optionally even during step 1, i.e., to hold the cable 12 in place throughout the entire fitting process. The fitting head 2 can now be opened (FIG. 8), thereby releasing the cable 12. The fitting head 2 is subsequently moved back to pick up the next grommet 11 from the transfer unit 7, which has meanwhile rotated 90°.

The flange portion 24 adjoins the expansion sleeve 3 and more precisely the cylindrical portion of the expansion sleeve 3. The expansion sleeve 3 is detachably fastened to or in the fitting head 2 via the flange portion 24. For this purpose, a housing 30 of the fitting head 2 has, for each shell part 26 having a plate-shaped flange portion 24, a pocket-shaped receiving opening, into which the particular shell part 26 is insertable and removable again via the associated flange portion 24.

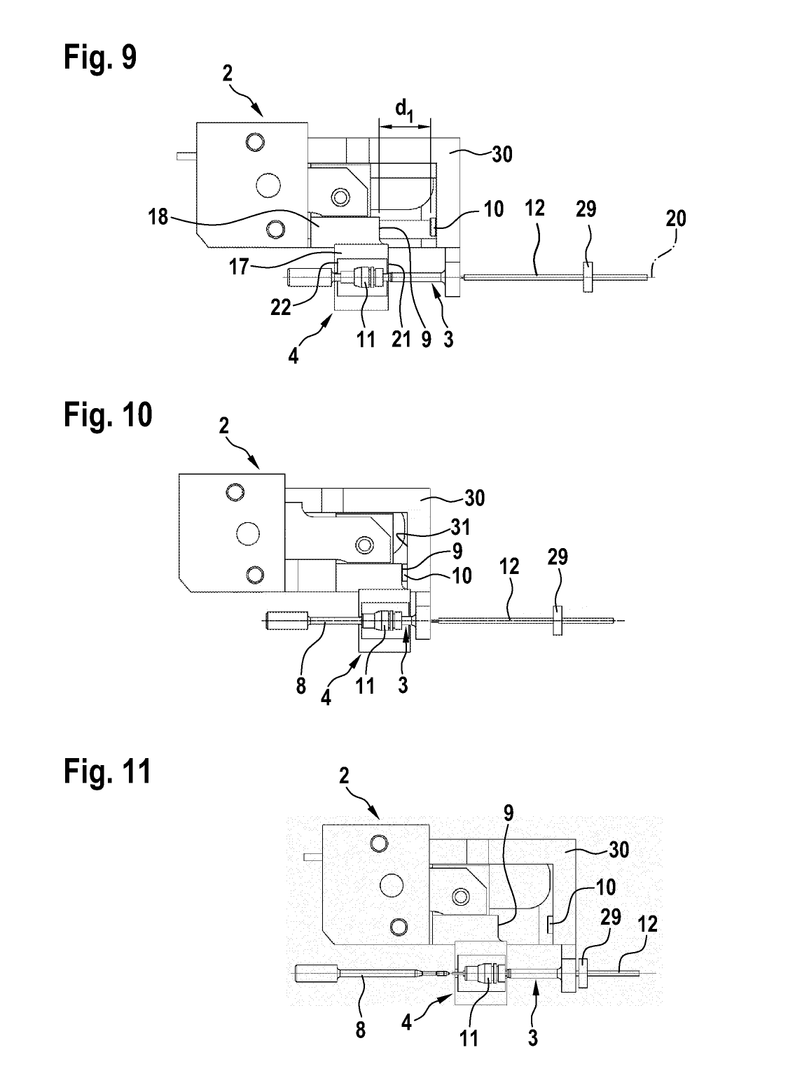

The position of the sliding-on and stripping drive shown in FIG. 6 must be maintained precisely, since, when sliding it onto the expansion sleeve 3, the grommet receiving part 4 may be moved only until the grommet receiving part 4 is located, at a preferably defined minimal distance, in front of the end of the expansion sleeve 3 formed by the flange portion 24. By means of the grommet receiving part 4, the grommet 11 is slidable onto the expansion sleeve 3 by a sliding-on travel, the sliding-on travel, which ultimately determines the position of the grommet 11 on the cable 12, also being referred to as the "sliding-on stroke." To define the sliding-on stroke, the grommet receiving part 4 is provided with a stop that cooperates with a counterpart associated with the expansion sleeve 3 to limit the maximum possible sliding-on stroke. How this sliding-on stroke is defined can be seen from FIG. 9 and the following FIGS. 10-11.

FIG. 9 shows the closed fitting head 2 of the grommet fitting module 1, which position corresponds to that in the preceding FIG. 4. For better understanding, only the parts of the fitting head 2 belonging to the upper block, as well as the grommet receiving portion 17 of the lower jaw 16, are shown. The grommet receiving part 4 has an end face 9 that forms the stop for defining the sliding-on stroke designated by d₁, wherein d₁ corresponds to the distance along the longitudinal center axis 20 from the end face 9 to the counterpart 10. The jaw 15 having the fastening portion 18 and grommet receiving portion 17 is L-shaped. The fastening portion 18 of the jaw 15 has an end facing the cable 12, i.e., a front end with respect to the longitudinal center axis 20 and the direction of movement, for forming the end face 9. The end face 9 is designed to be flat, thus resulting in a defined stop for particularly precise setting of the sliding-on stroke d₁. The lower jaw 16 also has such an end face (not shown here), which also forms a stop. The end face 9 is arranged offset rearward relative to a front end of the grommet receiving portion 17 in the jaw 15 of the grommet receiving part 4.

It can then be clearly seen from FIG. 9 that the grommet receiving portion 17 of the grommet receiving part 4 has two wall portions 21, 22 extending transversely to the longitudinal center axis 20 for sliding onto and stripping off the expansion sleeve 3. The grommet 11 can be pushed onto the expansion sleeve 3 with the rear wall portion 22, and the grommet 11 can be stripped off the expansion sleeve 3 with the front wall portion 21.

In FIG. 10, the grommet 11 is slid onto the expansion sleeve 3, i.e., the grommet receiving part 4 has been moved in the direction of the expansion sleeve 3 by the sliding-on stroke d₂. The end face 9 of the grommet receiving part 4 abuts the counterpart 10. The counterpart 10 for the stop is arranged in the housing 30 of the fitting head 2. This means that the counterpart 10 remains fixed and cannot be removed together with the expansion sleeve 3. The counterpart 10 is formed by a stud-shaped protrusion projecting relative to an inner side of the housing 30. This stamp, formed by the stud-shaped protrusion, is thus integrally connected to the adjacent inner side 31 of the housing 30 and arranged rigidly in the housing 30 of the fitting head 2. However, it would also be conceivable to connect the counterpart 10 formed by the stamp to the housing in a detachable manner, for example via a screw connection, so that, in order to expand the range of applications, the stud can be replaced with another stud having a different stud height. Furthermore, other shapes and designs for the counterpart 10 are also conceivable. The counterpart 10 does not necessarily have to have a flat contact surface. It can have a convex or, for example, a hemispherical contour.

The cable 12 may be brought to the grommet fitting module 1 with a cable gripper 29. However, during the fitting process, the cable gripper 29 is not moved, so the cable 12 remains stationary. The cable projection is substantially the distance from the free end of the cable to the gripper 29. In FIG. 10, the grommet 11 has been pulled off the expansion sleeve 3 and positioned on the cable 12. For this purpose, the fitting head 2 was moved to the right.

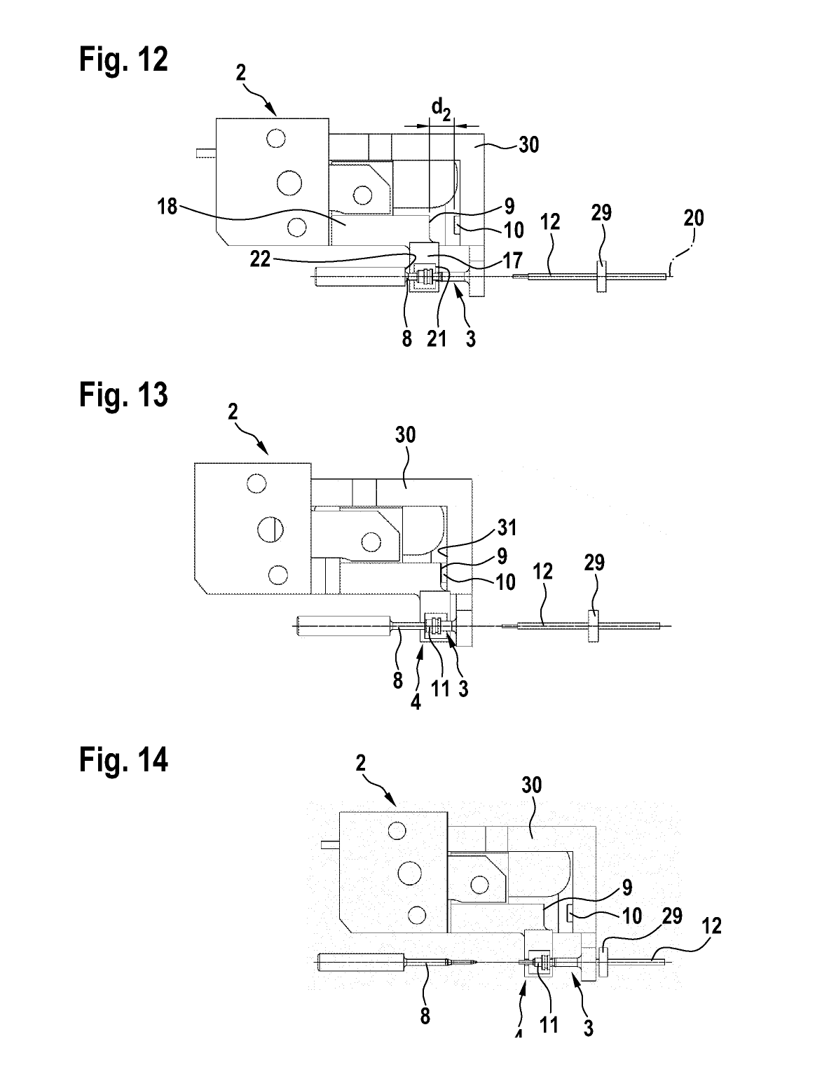

The grommet fitting module 1 is implemented such that it allows for simple and rapid changeover to different grommets. This aspect can be seen from FIG. 12, where the grommet fitting module 1 is configured for short grommets. For this purpose, the expansion sleeve 3 is implemented as a replaceable part, and the grommet receiving part 4, likewise is implemented as a replaceable part, which can be removed from the grommet fitting module 1 and replaced with others. After the tool change, the grommet fitting module 1 may have a shorter expansion sleeve 3 and a grommet receiving part 4 having a shorter grommet receiving portion compared to FIGS. 9-11. The sliding-on stroke d₂ is also much shorter in this embodiment.

What is claimed is:

1. A grommet fitting module for fitting a grommet onto a cable end of a cable, comprising:
a fitting head including an expansion sleeve and a grommet receiving part, wherein the expansion sleeve holds a grommet in an expanded state, and wherein the grommet receiving part receives and holds the grommet during a fitting process and places the grommet onto the cable end; and
a transfer unit including at least one mandrel, wherein a grommet is moved onto the at least one mandrel in a pick-up position of the at least one mandrel, and wherein the at least one mandrel, in a transfer position, is operatively coupled to the fitting head such that the grommet can be transferred from the at least one mandrel to the fitting head;
wherein the expansion sleeve of the fitting head temporarily surrounds the at least one mandrel in the transfer position to move the grommet onto the expansion sleeve through an axial movement of the grommet receiving part;
wherein the grommet is moved from the expansion sleeve onto the cable by the grommet receiving part;
wherein at least one of the expansion sleeve or the grommet receiving part is a replaceable part that is detachably fastened to the fitting head;
wherein a sliding-on stroke occurs when at least one of the expansion sleeve or the grommet receiving part is separated from the fitting head, ; and
wherein at least one of the grommet receiving part or the expansion sleeve includes a stop, wherein the stop cooperates with a counterpart associated with at least one of the expansion sleeve or the grommet receiving part.

2. The grommet fitting module according to claim 1, wherein the grommet receiving part has an end face that forms the stop for the sliding-on stroke.

3. The grommet fitting module according to claim 2, wherein the grommet receiving part is formed in two parts and has two radially counter-movable jaws having receptacles for the grommet, wherein each of the jaws includes a grommet receiving portion having a recess forming a grommet receptacle, wherein each of the jaws includes a fastening portion adjoining the grommet receiving portion, and wherein the end face is formed by each respective fastening portion.

4. The grommet fitting module according to claim 3, wherein each of the jaws of the grommet receiving part is formed as a one-piece component.

5. The grommet fitting module according to claim 3, wherein the grommet receiving portion is a hollow body having a frame structure that is generally rectangular in plan view, wherein the grommet receiving portion includes two parallel wall portions for sliding onto and stripping off the expansion sleeve.

6. The grommet fitting module according to claim 3, wherein the fastening portion of each of the jaws has a front end for forming the end face.

7. The grommet fitting module according to claim 6, wherein the front end of the fastening portion forming the stop is arranged offset rearward relative to the grommet receiving portion.

8. The grommet fitting module according to claim 3, wherein the grommet receiving part includes a support part for each of the jaws, wherein the support parts and the jaws are radially counter-movable between an open position and a closed position, and wherein each of the support parts has a workpiece receptacle for positive insertion of the fastening portion into the workpiece receptacle.

9. The grommet fitting module according to claim 1, further comprising a sleeve holder having a flange portion including a funnel-shaped insertion portion adjoining the expansion sleeve, wherein the expansion sleeve is formed in two parts and includes two radially counter-movable shell parts, and wherein the expansion sleeve is detachably fastened to the fitting head via the flange portion of the sleeve holder.

10. The grommet fitting module according to claim 1,wherein the counterpart for the stop is arranged in or on a housing of the fitting head.

11. The grommet fitting module according to claim 1, wherein the counterpart for the stop is arranged on the expansion sleeve and a flange portion, wherein the flange portion is a sleeve holder, and wherein the sleeve holder together with the expansion sleeve is removeable from the fitting head and replaceable.

12. The grommet fitting module according claim 1, wherein the counterpart is a stud-shaped stamp.

13. The grommet fitting module according to claim 12, wherein the stud-shaped stamp is integrally arranged in an adjacent inner side of a housing of the fitting head.

14. The grommet fitting module according to claim 10, wherein the housing of the fitting head includes a pocket-shaped receiving opening formed in at least one shell part of the expansion sleeve, wherein the at least one shell part includes a plate-shaped flange portion, and wherein the at least one shell part is removably replaceable within the corresponding pocket-shaped receiving opening via the corresponding flange portion.

15. The grommet fitting module according to claim 1, further comprising a pneumatic head drive for moving the fitting head along a longitudinal center axis and a pneumatic sliding-on and stripping drive, wherein the pneumatic head drive includes a plurality of pneumatic cylinders, and wherein the pneumatic sliding-on and stripping drive includes at least one pneumatic cylinder.
